(19) United States
(12) Patent Application Publication
(10) Pub. No.: US 2005/0092571 A1
(43) Pub. Date: May 5, 2005

(54) Vehicle air conditioner using variable control compressor

(76) Inventor: Tae-Wan Kim, Hwaseong-city (KR)

Correspondence Address: MORGAN, LEWIS & BOCKIUS LLP (SF), 2 PALO ALTO SQUARE, PALO ALTO, CA, 94306, US

(21) Appl. No.: 10/962,027

(22) Filed: Oct. 8, 2004

(30) Foreign Application Priority Data
Oct. 29, 2003 (KR) 10-2003-0075887

(51) Int. Cl. F16D 28/00

(52) U.S. Cl. 192/21.5; 192/84.1

(57) ABSTRACT

The vehicle air conditioner includes a compressor that compresses the refrigerant of an air conditioner by receiving rotational force from the engine. A clutch transmits or isolates the rotational force of the engine to a compressor shaft by using an operational fluid. A shearing force of the operational fluid varies according to the variation of the magnetic field. A controller varies the shearing force of the operational fluid by adjusting the magnetic field according to the cooling load.

### CROSS-REFERENCE TO RELATED APPLICATIONS

This application claims priority of Korean Application No. 10-2003-0075887, filed on Oct. 29, 2003, the disclosure of which is incorporated fully herein by reference.

### FIELD OF THE INVENTION

The present invention relates to a vehicle air conditioner. More particularly, the present invention relates to a vehicle air conditioner using a variable control compressor that operates based on the cooling load.

### BACKGROUND OF THE INVENTION

Vehicles are equipped with air conditioner to refresh the air inside a passenger compartment by adjusting the temperature and moisture of the compartment. In the air conditioner, a driving pulley of the compressor is connected via a belt with a pulley that integrally rotates with the crankshaft of the engine, which transmits the rotational force of the engine to the compressor. A clutch is provided to restrict the power from the engine to prevent an overload caused by high pressure of the compressor.

If the driver activates the air conditioner for cooling the passenger compartment, battery power of the vehicle is applied to an electronic clutch through an air conditioner driving relay. An electronic clutch plate engages with the driving pulley of the compressor by a magnetic coil mounted inside the electronic clutch, and the rotational force of the engine is transmitted to the driving shaft of the compressor. However, once the power is disengaged, the clutch plate is separated from the pulley and the pulley runs idle on a bearing, thereby isolating the power transmission thereof.

The compressor using the electronic clutch thus described receives the rotational force of the engine and is activated or deactivated according to the given logic of a controller. The controller restricts the degree of cooling during the operation of the compressor. The compressor discharges refrigerant based on the amount per revolutions prescribed by its design. However, in order to allow the conventional compressor that discharges a certain amount of refrigerant to control the temperature of the passenger compartment, the electronic clutch constantly repeats the connecting and separating operations, thereby causing continuous noise.

Furthermore, the same amount of refrigerant is discharged to cool the passenger compartment, notwithstanding the varying temperature range of the passenger compartment, because the amount of refrigerant discharge is preset and there is a lack of an adjusting mechanism to control the amount of refrigerant discharge in such conventional system. This results in increased fuel consumption.

Furthermore, where the rotational force of the engine is transmitted by contact with the electronic clutch, a strong rotational force of the engine is directly transmitted as the compressor connects with the electronic clutch. This results in the generation of a slugging noise, which occurs when the refrigerant heavily strikes the inner part thereof during the initial operation of the compressor.

### SUMMARY OF THE INVENTION

An embodiment of the present invention is provided to prevent the increase of fuel consumption caused by unnecessarily discharging refrigerant by varying the rotational force. The rotational force is transmitted from the engine to a compressor, according to the required degree of cooling. The present invention is also provided to prevent the generation of noise during the power transmission.

In some embodiments, a vehicle air conditioner using a variable control compressor according to the cooling load comprises a compressor that compresses the refrigerant of an air conditioner by receiving the rotational force of the engine. A clutch transmits or isolates the rotational force of the engine to a compressor shaft by using an operational fluid, wherein the shearing force of the operational fluid varies according to the variation of the magnetic field. A control means varies the shearing force of the operational fluid by adjusting the magnetic field according to the cooling load.

The clutch includes a chamber packed with operational fluid. A rotating disk is rotatably disposed in the chamber and is connected with the compressor shaft. A magnetic coil generates the magnetic field at one side of the chamber according to the amount of current provided from the exterior and varies the shearing force of the operational fluid.

The control means is designed to allow a controller to activate a current amplifier on the basis of a measuring signal of a sensor that measures the refrigerant pressure and adjusts the amount of current provided to the magnetic coil.

According to some embodiments there is provided a vehicle air conditioner that includes a compressor and a clutch. The compressor includes a compressor shaft. The clutch includes an input, an output, an operational fluid, and a magnetic field source. The input is configured to be coupled to a vehicle engine. The input may be a pulley configured to be coupled to an additional pulley via a belt, where the additional pulley is coupled to a crankshaft of the vehicle engine. The output is coupled to the compressor shaft. In some embodiments, the output may be a rotating disk rotatably disposed within a chamber of the clutch. The operational fluid is disposed between the input and the output and may be contained within the chamber. The magnetic field source is configured to generate a magnetic field that alters the characteristics of the operational fluid to vary the coupling strength between the input and the output. The vehicle air conditioner may also include a controller electrically coupled to the magnetic field source to alter the current transmitted to the magnetic field source, thereby altering the magnetic field. The vehicle air conditioner may also include a current amplifier electrically coupled between the controller and the magnetic field source, and a sensor configured to measure and transmit a pressure of refrigerant within the vehicle air conditioner to the controller. In some embodiments, the magnetic field source is a magnetic coil.

### BRIEF DESCRIPTION OF THE DRAWINGS

For a better understanding of the nature and objects of the present invention, reference should be made to the following detailed description with the accompanying drawings, in which:

FIG. 1 is a composite view of a variable control compressor in relation to a cooling load according to an embodiment of the present invention; and

FIG. 2 is a graph of a shearing force of a Magneto-Rheological (MR) fluid and the magnetic field according to an embodiment of the present invention.

### DETAILED DESCRIPTION OF THE PREFERRED EMBODIMENTS

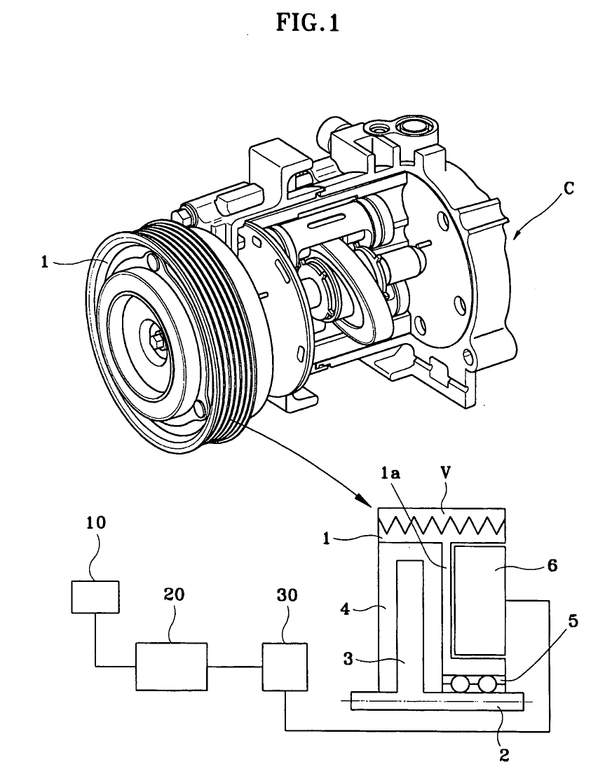

Referring to FIG. 1, a vehicle air conditioner using a variable control compressor according to the cooling load comprises a compressor (C) that compresses the refrigerant of an air conditioner by receiving a rotational force from a vehicle's engine. A clutch activates the compressor (C) by transmitting the rotational force of a pulley 1, which is connected via a belt to a pulley equipped on the crankshaft of the engine, to a driving shaft 2 through a rotating disk 3. The rotating disk 3 is disposed inside an operational fluid 4 packed in a chamber for changing its physical characteristic according to the variation of the magnetic force of a magnetic coil 6. The clutch also restricts the engine power by having the pulley 1 run idle via a bearing 5 during compressor (C) overload.

A control means receives a measuring signal of a sensor 10 that measures the pressure of the operational fluid of the air conditioner, such as the refrigerant. The control means sends a control current via a current amplifier 30 to the magnetic coil 6 for controlling the operation state of the clutch. The control current is generated by a controller 20 that determines whether the air conditioner is operating.

The operational fluid 4 and magnetic coil 6 that together make up the clutch are demarcated by an isolating wall 1a of the pulley 1.

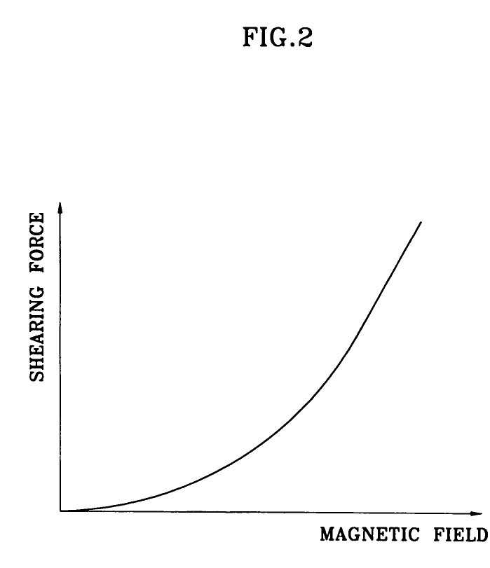

The operational fluid 4 is a non-colloid solution such as Magneto-Rheological (MR) fluid, which disposes particles having a magnetic property of a micron size into a non-conductor solution such as silicon oil, mineral oil or the like. As shown in FIG. 2, when the magnetic field is not loaded, the dispersed particles of the fluid have Newtonian fluid characteristics, however, once a magnetic field is applied, then a fiber is formed in a parallel direction to the applied magnetic field by the polarization of the dispersed particles. This creates a shearing resistance force in relation to its flow.

A microprocessor is typically used as the controller 20, however, an Engine Control Unit (ECU) is preferably used.

A preferred embodiment of the present invention will now be described in detail with reference to the attached drawings. When a driver activates a switch of an air conditioner for cooling the passenger compartment, a control means detects that the air conditioner is operating and applies the battery power of the vehicle via an air conditioner driving relay to a clutch mounted at a compressor (C). If the physical characteristic of the operational fluid 4 such as MR fluid changes according to the variation of the magnetic field of the magnetic coil 6 mounted inside the clutch, a shearing force is applied to the rotating disk 3 by the operational fluid 4. The rotational force of the pulley 1 received from the engine via the belt (V) is, thereby, transmitted to the driving shaft 2 for activating the compressor (C).

On the other hand, if the driver deactivates the switch of the air conditioner, the control means determines that the air conditioner is not operating, and thus, power is not provided to the clutch mounted inside the compressor (C). Further, the operational fluid 4 changes to its initial state when the magnetic field of the magnetic coil 6 is removed. This causes the pulley 1 to run idle on the bearing 5 and isolates the power transmission of the engine.

In the present invention, the amount of refrigerant discharge from the compressor varies based on the operational conditions of the air conditioner. That is, when the sensor 10 measures the pressure of the refrigerant and sends it to the controller 20, the controller 20 determines an appropriate current to discharge an appropriate amount of refrigerant based on the degree of cooling required and sends a control signal.

When the control signal of the controller 20 is transmitted through the current amplifier 30 to the magnetic coil 6 of the clutch, the shearing force of the operational fluid 4 changes proportionally to the size of the magnetic force, based on the amount of the current supplied to the magnetic coil 6. This is shown in FIG. 2. The rotating disk 3 of the clutch receives the shearing force, and the rotational force of the pulley 1 received from the engine via the belt (V) is transmitted to the driving shaft 2 to operate the compressor (C).

Provided that the current transmitted to the magnetic coil 6 is maximized, then the shearing force of the operational fluid 4 inside the clutch is also maximized, resulting in an optimization of the adhesive fixing force with the rotating disk 3, and the rotational force of the engine is directly transmitted to the driving shaft 2. However, if the current diminishes, the shearing force of the operational fluid 4 also reduces, causing the rotating disk 3 to skid and producing less revolutions compared to the engine rotations. The diminished rotational force of the compressor (C) causes a reduction in the amount of the refrigerant discharge. Therefore, this can be applied to adjust the cooling load.

That is, if the controller 20 detects the increase of the cooling load through the sensor 10, the controller 20 provides the maximum current to the magnetic coil 6 so that the cooling system may perform maximally be performed by the amount of refrigerant discharge increased via the maximum rotational force of the compressor (C). On the other hand, if the controller 20 determines via the sensor 10 that the cooling load is decreasing, the current provided to the magnetic coil 6 is minimized for minimizing the rotational force of the compressor (C). The cooling system may minimally be maintained by minimizing the rotational force of the compressor (C).

As apparent from the foregoing, there is an advantage in the present invention in that the transmitting degree of the revolution of the clutch is variably adjusted according to the required degree of the cooling load, wherein the clutch rotates the compressor discharging the refrigerant by transmitting the engine rotational force, thereby preventing unnecessary fuel consumption even during operation of the air conditioner.

There is another advantage in that the degree of the current provided to the clutch can be adjusted by gradually increasing the engagement force of the clutch during the initial operation of the compressor, wherein the clutch transmits the rotational force of the engine. This prevents generation of the noise of the refrigerant caused by the transmission of the strong rotational force of the engine.

There is a further advantage in that the connection of the clutch can be gradually carried out according to the degree of the current, effectively eliminating noise that occurs due to the frequent operation of the connection and separation of the clutch.

1. A vehicle air conditioner using a variable control compressor, comprising:
a compressor for compressing refrigerant of an air conditioner through a rotational force from an engine;
a clutch for selectively transmitting the rotational force of the engine to a compressor shaft of the compressor by using an operational fluid, wherein a shearing force of said operational fluid varies according to a variation of a magnetic field applied to the operational fluid; and
control means for varying the shearing force of said operational fluid by adjusting the magnetic field based on a cooling load.

2. The vehicle air conditioner as defined in claim 1, wherein said clutch includes:
a chamber packed with said operational fluid;
a rotating disk rotatably disposed in said chamber and connected to said compressor shaft; and
a magnetic coil for generating a magnetic field at one side of said chamber based on the amount of current received, and varying the shearing force of said operational fluid.

3. The vehicle air conditioner as defined in claim 2, wherein said operational fluid and magnetic coil are demarcated by an isolating wall of a pulley connected via a belt with a pulley equipped on a crankshaft of the engine.

4. The vehicle air conditioner as defined in claim 1, wherein said control means is designed to allow a controller to activate a current amplifier to adjust the amount of the current provided to said magnetic coil on the basis of a measuring signal of a sensor that measures a refrigerant pressure.

5. The vehicle air conditioner as defined in claim 1, wherein said operational fluid is a Magneto-Rheological fluid.

6. A vehicle air conditioner comprising:
a compressor having a compressor shaft;
a clutch comprising:
an input configured to be coupled to a vehicle engine;
an output coupled to said compressor shaft;
an operational fluid disposed between said input and said output; and
a magnetic field source configured to generate a magnetic field that alters the characteristics of said operational fluid, thereby varying coupling strength between said input and said output.

7. The vehicle air conditioner of claim 6, further comprising a controller electrically coupled to said magnetic field source to alter the current transmitted to said magnetic field source, thereby altering said magnetic field.

8. The vehicle air conditioner of claim 7, further comprising a current amplifier electrically coupled between said controller and said magnetic field source.

9. The vehicle air conditioner of claim 7, further comprising a sensor configured to measure and transmit a pressure of refrigerant within the vehicle air conditioner to said controller.

10. The vehicle air conditioner of claim 6, wherein said magnetic field source is a magnetic coil.

11. The vehicle air conditioner of claim 6, wherein said clutch includes a chamber containing said operational fluid.

12. The vehicle air conditioner of claim 1 1, wherein said output is a rotating disk rotatably disposed within said chamber.

13. The vehicle air conditioner of claim 6, wherein said input is a pulley configured to be coupled to an additional pulley via a belt, where said additional pulley is coupled to a crankshaft of said vehicle engine.

14. The vehicle air conditioner of claim 6, wherein said operational fluid is a Magneto Rheological fluid.
